(19) United States
(12) Patent Application Publication
(10) Pub. No.: US 2015/0062619 A1
(43) Pub. Date: Mar. 5, 2015

(54) IMAGE FORMING APPARATUS, METHOD FOR CONTROLLING IMAGE FORMING APPARATUS, AND PROGRAM

(71) Applicant: CANON KABUSHIKI KAISHA, Tokyo (JP)

(72) Inventor: Akinori Watanabe, Yokohama-shi (JP)

(21) Appl. No.: 14/473,926

(22) Filed: Aug. 29, 2014

(30) Foreign Application Priority Data
Sep. 2, 2013 (JP) 2013-181330

(51) Int. Cl. G06F 3/12; G06K 15/02

(52) U.S. Cl. CPC G06F 3/1221; G06K 15/1828
USPC 358/1.14

(57) ABSTRACT

In an image forming apparatus which includes a first memory configured to store a program for executing a specific process, and a second memory configured to store a program read from the first memory, in a case in which the image forming apparatus shifts to a specific state, a content of the program stored in the second memory is verified. In accordance with the verification result, control is made to write the program read from the first memory in the second memory.

### BACKGROUND OF THE INVENTION

1. Field of the Invention

The present invention relates to an image forming apparatus, a method for controlling an image forming apparatus, and a program.

2. Description of the Related Art

Many of information processing apparatuses have programs to be started up stored in external storage apparatuses, such as hard disk drive and flash memory. The information processing apparatuses make the following control: when a main power supply is started, program data stored in the external storage apparatus is developed to volatile memory (e.g., dynamic random access memory (DRAM)) which is a main storage apparatus, and then the developed program is executed.

For this reason, when the power supply of the information processing apparatus is turned OFF, data developed to the volatile memory is deleted. Therefore, there has been a problem that it is necessary to develop the program data to the volatile memory each time when the power supply of the information processing apparatus is started and this developing time prolongs a start-up process of the entire information processing apparatus.

Recently, as replacement of DRAM which is volatile memory, non-volatile memory (e.g., magnatoresistive random access memory (MRAM)) has been used. Developed data of a compression program read from read only memory (ROM) is stored in the non-volatile memory to which data can be read and written at the same access speed as that to DRAM at the initial start-up. Then, a start-up process is performed by reading and executing a program from the non-volatile memory. For the second or subsequent start-up process, in a case in which there has been no change in the configuration of the information processing apparatus, the program is executed as it is from the non-volatile memory. On the other hand, in a case in which there has been a change in the configuration of the information processing apparatus or abnormality has occurred in the program stored in the non-volatile memory, a means to perform the initial start-up process is also proposed (Japanese Patent Laid-Open (JP-A) No. 2013-4042 and No. 2013-4043).

In an information processing apparatus, as a configuration which uses non-volatile memory more effectively on a system, a hybrid configuration in which volatile memory is used as work memory by using, for example, non-volatile memory and volatile memory which have compatibility as interfaces connected to the same bus, storing a program data in the non-volatile memory, reading and executing the program data at the time of start-up is considered to be optimum.

In a case in which, however, the configuration described above is adopted, since the non-volatile memory and the volatile memory establish complete interface compatibility and are connected to the same bus, the non-volatile memory side may also be used as work memory. For this reason, there is a possibility that, if the program data stored in the non-volatile memory is wrongly rewritten, an error occurs and the apparatus no more functions as the information processing apparatus.

Further, in JP-A No. 2013-4042 and No. 2013-4043, there is a problem that, in a case in which the configuration of the information processing apparatus is changed or abnormality occurs in the stored program, it is necessary to perform the initial start-up process that takes time.

### SUMMARY OF THE INVENTION

An object of the present invention is to reconstruct a program in a second memory in a case in which the program written in the second memory from a first memory has been changed.

An image forming apparatus according to the present invention includes: a first memory configured to store a program for executing a specific process; a second memory configured to store a program read from the first memory; a verifying unit configured to, in a case in which the image forming apparatus shifts to a specific state, verify a content of the program stored in the second memory; and a first control unit configured to, in accordance with the verification result by the verifying unit, write the program read from the first memory in the second memory.

An image forming apparatus according to the present invention includes: a first memory configured to store a program for executing a specific process; a second memory configured to store a program read from the first memory; and a second control unit configured to, in a case in which the image forming apparatus shifts to a specific state, write the program read from the first memory in the second memory.

Further features of the present invention will become apparent from the following description of exemplary embodiments with reference to the attached drawings.

### BRIEF DESCRIPTION OF THE DRAWINGS

FIG. 1 is a block diagram illustrating an image processing system configuration that includes an image forming apparatus.

FIG. 2 is a diagram illustrating a memory map of ROM and MRAM.

FIG. 3 is a flowchart illustrating a method for controlling an image forming apparatus.

FIGS. 4A to 4C are diagrams illustrating a power supply state of an image forming apparatus.

FIG. 5 is a diagram illustrating state transition corresponding to a change of a power supply state of an image forming apparatus.

FIG. 6 is a flowchart illustrating a method for controlling an image forming apparatus.

### DESCRIPTION OF THE EMBODIMENTS

Next, the best form for carrying out the present invention will be described with reference to the drawings.

### Description of System Configuration

Hereinafter, the best form for carrying out the present invention will be described with reference to the drawings.

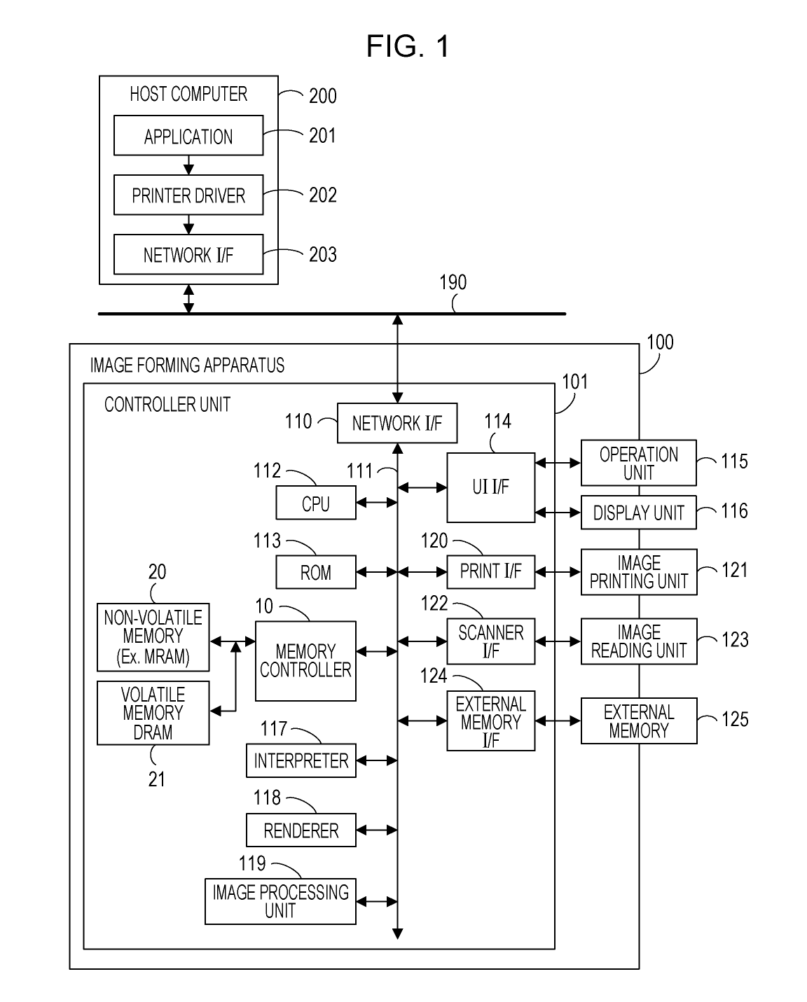

FIG. 1 is a block diagram illustrating an image processing system configuration that includes an image forming apparatus representing the present embodiment. In this example, a host computer 200 which is made to function as an information processing apparatus and an image forming apparatus 100 are connected to each other via an external network 190. The host computer 200 sends a drawing command to the image forming apparatus 100 which converts the received command into outputtable image data and outputs the converted command to a paper sheet.

In FIG. 1, the host computer 200 consists of an application 201, a printer driver 202 and a network I/F 203. The application 201 operates on the host computer 200. Using the application 201, a user may create a page layout document, a word processor document, a graphic document and the like.

Digital document data created using the application 201 is transmitted to a printer driver 202 and a drawing command in accordance with the digital document is generated. As the drawing command generated by the printer driver 202, a printer description language for creating page image data called page description language (PDL) is commonly used. The drawing command usually includes drawing instructions of data such as characters, graphics and images.

The generated drawing command is transmitted to the image forming apparatus 100 via the network I/F 203 and then via the external network 190.

The image forming apparatus 100 includes a controller unit 101, an image printing unit 121 and an image reading unit 123. The controller unit 101 includes a central processing unit (CPU) 112 as an example of execution unit or a recognition unit that controls each part of the image forming apparatus 100 by implementing plural operations. Various types of data is exchanged via a data bus 111 which is connected to the CPU 112.

The controller unit 101 includes ROM 113, non-volatile memory (MRAM) 20 and volatile memory (DRAM) 21. The ROM 113, the MRAM 20 and the DRAM 21 are connected to the data bus 111.

The controller unit 101 further includes a display unit 116 that displays an user interface (UI) screen on which instructions to the user and the state of the image forming apparatus 100 are displayed, and an operation unit 115 for receiving an input from the user, and controls input/output via an UI I/F unit 114.

The image printing unit 121 is connected to the data bus 111 via a print interface unit 120. The image reading unit 123 is connected to the data bus 111 via a scanner I/F 122. In order to implement function extension, the image forming apparatus 100 has a configuration to which external memory 125 is attachable, and is connected to the external memory 125 via an external memory I/F 124.

A network I/F 110 is an interface module with the external network 190. Bidirectional data communication, such as reception of a drawing command from other devices via the external network 190 in accordance with a communication protocol, such as the Ethernet (registered trademark), and transmission of device information of the image forming apparatus 100 (e.g., jam information and paper size information), is performed.

An interpreter 117 interprets the drawing command received via the network I/F 110 and generates intermediate language data. A renderer 118 generates a raster image from the generated intermediate language data. An image processing unit 119 performs image processing, such as a color conversion process, a γ correction process using a look-up table, and a pseudo halftone process, to the generated raster image.

A memory controller 10 performs data transmission and reception control of the MRAM 20 and the DRAM 21.

The image printing unit 121 connected to the controller unit 101 forms an image on the paper sheet with toner in accordance with the outputtable image data that has been converted in the print I/F 120. In the controller unit 101, the CPU 112 may access the ROM 113, the MRAM 20 and the DRAM 21 via the memory controller 10.

Here, the ROM 113 as an example of a first storage unit consists of, for example, mask ROM, various types of programmable ROM (PROM), such as one time programmable ROM (OTP ROM), ultra-violet erasable programmable ROM (UV-EPROM) and electrically erasable programmable ROM (EEPROM) and flash memory. In this example, flash memory is used as the ROM 113.

The MRAM 20 as an example of a second storage unit consists of a memory that may retain stored information without power supply, such as MRAM, ferroelectric RAM (FeRAM), phase change RAM (PRAM) and resistance RAM (ReRAM). In the present embodiment, MRAM to which data is read and written at a higher speed than to the ROM 113 is used as the MRAM 20.

Further, the DRAM 21 consists of volatile memory that is not able to retain stored information without power supply, such as DRAM and static RAM (SRAM). In this example, DRAM is used as the volatile memory.

In this embodiment, the MRAM 20 and the DRAM 21 are compatible, are connected to the same bus and have equivalent reading and writing performance.

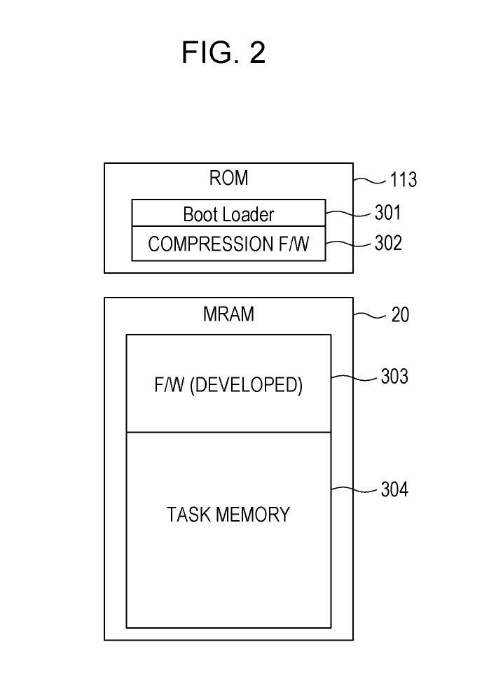

FIG. 2 is a diagram illustrating a memory map of the ROM 113 and MRAM 20 illustrated in FIG. 1.

In FIG. 2, the CPU 112 implements the function of the image forming apparatus 100 by performing start-up process in accordance with a boot loader 301 which is an initialization program of the ROM 113 and, then, causing an OS and a task to operate using task memory 304 by using a F/W (developed) 303 stored in the MRAM 20 which is a main program of the CPU 112.

The F/W (developed) 303 stored in the MRAM 20 described above shall be written in the MRAM 20 before being incorporated in the image forming apparatus 100. Therefore, it is possible to save the processing time to read the compression F/W 302 in the ROM 113 and to write in the DRAM 21 after developing the data that has been necessary at the time of start-up in the related art.

As described above, the compression F/W 302 is stored in the ROM 113 and the ROM 113 is configured as backup memory that stores backup data of the data developed to the MRAM 20. Therefore, even if an error occurs in the data of the F/W (developed) 303 stored in the MRAM 20, it is possible to address the error.

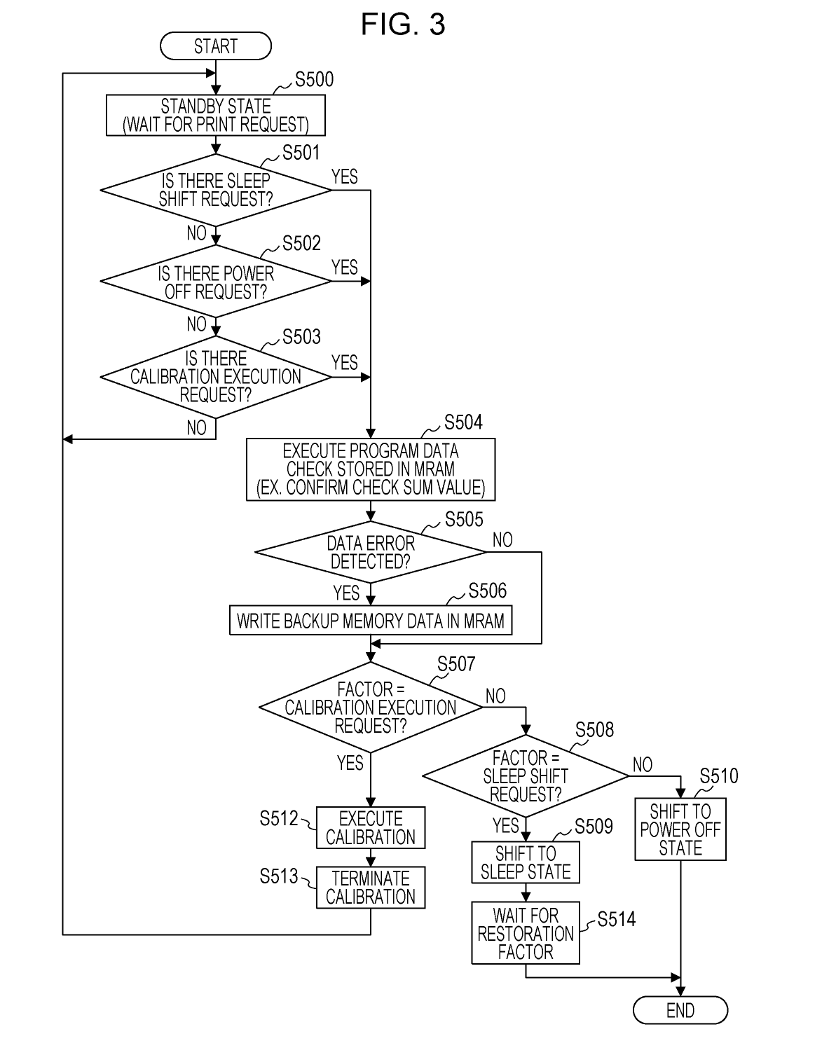

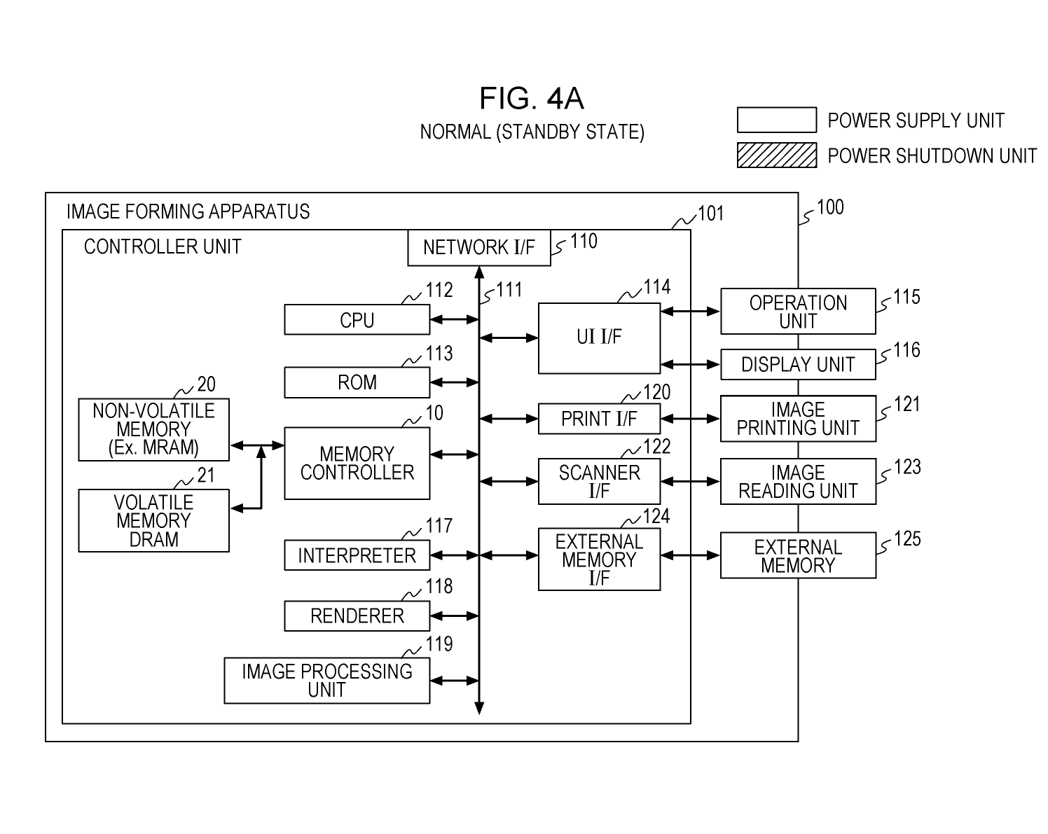

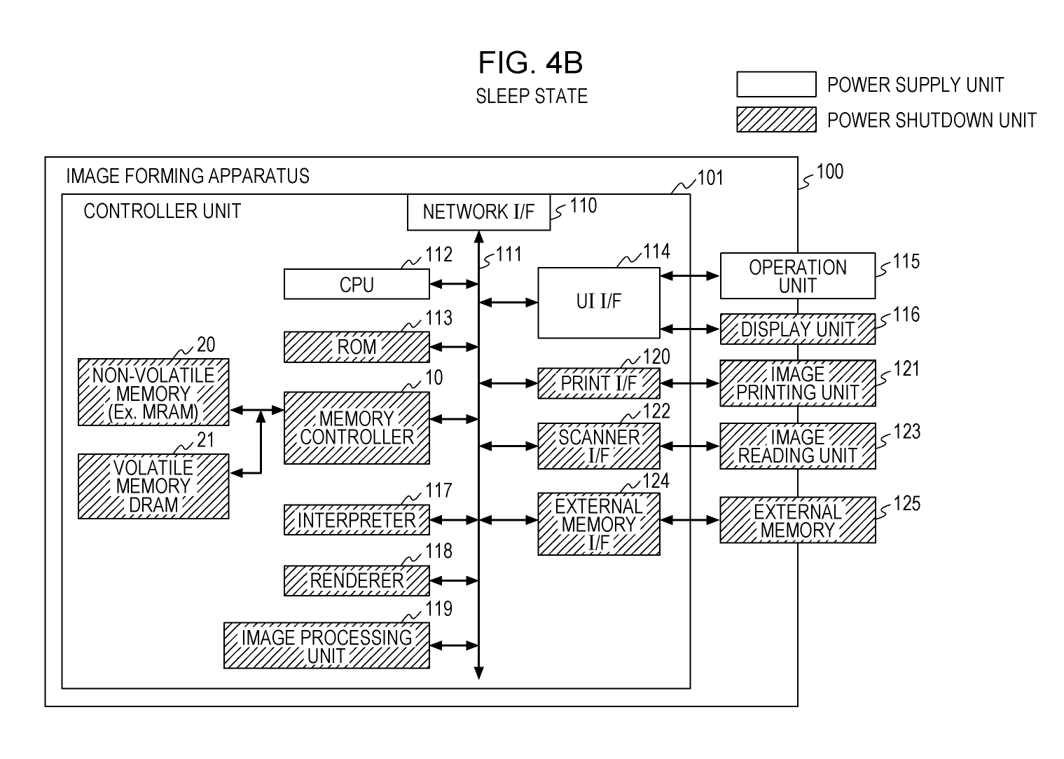

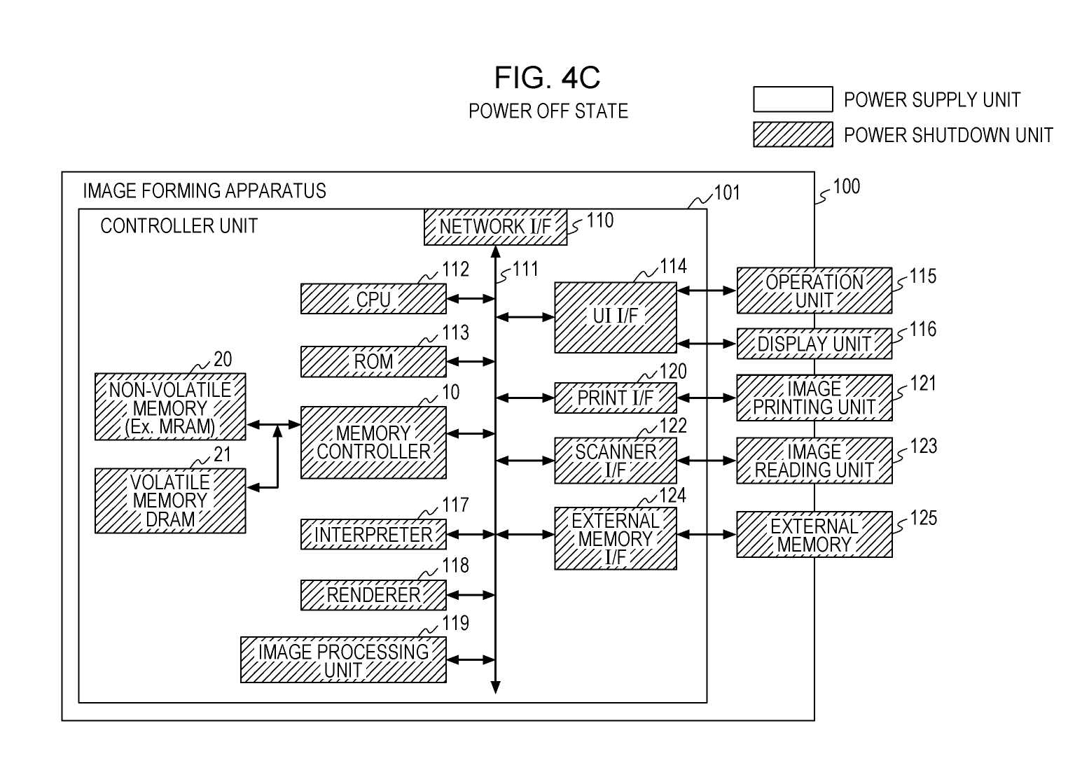

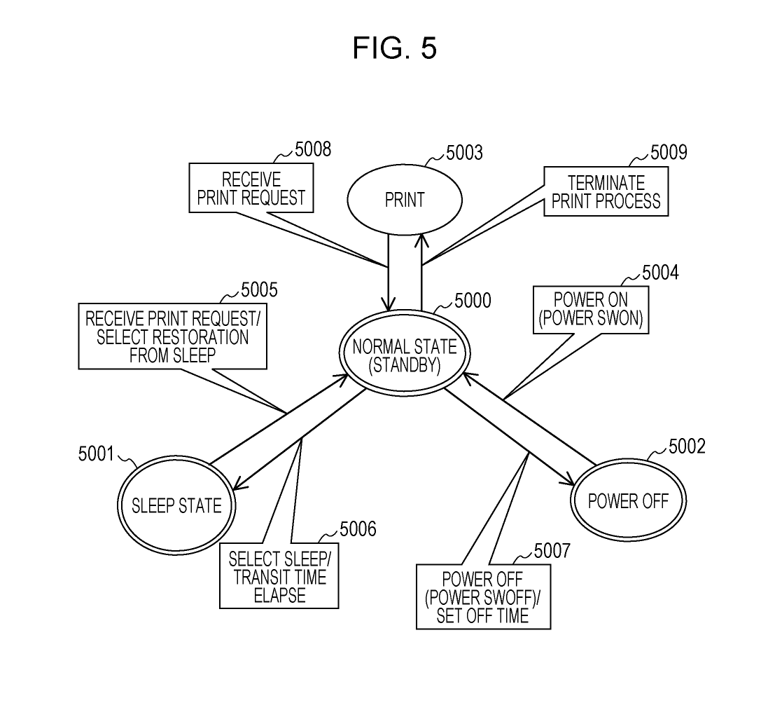

FIG. 3 is a flowchart illustrating a method for controlling the image forming apparatus 100 which represents the present embodiment. This is an example in which the CPU 112 performs checking and writing with respect to the F/W (developed) 303 stored in the MRAM 20. Hereinafter, with reference to state diagrams illustrated in FIGS. 4A to 4C and 5, a state and state transition of the image forming apparatus 100 will be described. Each step is implemented by the CPU 112 executing control programs. Hereinafter, in a case in which the image forming apparatus shifts to a specific state, the control to verify the content of a program stored in the second memory and, in accordance with the verification result, to write the program read from the first memory in the second memory will be described.

In the image forming apparatus 100, after turning on and starting up, the image forming apparatus 100 shifts to a standby state which is a waiting state for a print request (S500). The standby state refers to, as illustrated in FIG. 4A, a state in which power is supplied to all the parts that constitute the controller unit 101 and a state waiting for a reception of a print request via, for example, the network I/F 110. In the state transition illustrated in FIG. 5, the standby state corresponds to a normal state (a standby state) 5000.

Recently, from the viewpoint of energy saving, many products have a function of causing the apparatus to shift to the sleep state 5001 in which power consumption of the apparatus is reduced to the minimum under conditions in which, for example, the standby state continues a certain period of time and during which no print request is issued. Here, the sleep state refers to a state after the image forming apparatus 100 shifts to a second power state in which power is more saved than in a first power state (the standby state in which printing can be made).

It is premised in the present embodiment that the function is supported. The state described above is a state in which, as illustrated in FIG. 4B, power supply is blocked from all the parts except for the parts necessary to restore from the sleep state 5001 in each part constituting the controller unit 101 (e.g., the CPU 112, the UI I/F unit 114, the network I/F 110 and the operation unit 115).

In the state transition diagram illustrated in FIG. 5, the state described above corresponds to a state in which the image forming apparatus 100 has shifted to the sleep state 5001 from a print state 5003. The image forming apparatus 100 shifts from the standby state 5000 to the sleep state 5001 when the user selects sleep by operating, for example, the operation unit 115 or when previously set sleep transit time elapses 5006. The image forming apparatus 100 restores from the sleep state 5001 to the standby state 5000 when a print request is received via the network I/F 110 or when the user selects select restoration from sleep 5005 by operating, for example, the operation unit 115. In the present embodiment, the print state refers to a state in which the image printing unit 121 is able to form an image on the sheet.

In FIG. 3, in a case in which the CPU 112 determines that a shift request to the sleep state has been received (S501), the CPU 112 checks the data of the F/W (developed) 303 stored in the MRAM 20 (S504).

As an example of a method for checking in the verification process of the present embodiment, a checksum value is calculated from the data stored in the MRAM 20 and compared with a value stored in the ROM 113. Another method is, for example, temporarily developing the compression F/W 302 stored in the ROM 113 to the DRAM 21 and comparing the data of the MRAM 20 in certain area units. Note that the ROM 113 may be referred also to as boot ROM.

In this manner, after data check is performed, if the CPU 112 detects a data error (i.e., if the contents of the programs are inconsistent) (S505), the CPU 112 directly develops the data of the compression F/W 302 stored in the ROM 113 to the MRAM 20 and performs writing (S506).

Regarding the write-in unit, in a case in which the check is performed with respect to all the areas, all the F/W (developed) 303 may be written and, in a case in which the check is performed in predetermined area units, only areas in which errors have occurred may be written.

Regarding the writing unit, the CPU 112 starts the boot loader 301 of the ROM 113, develops the compression F/W 302 stored in the ROM 113 as backup data, and writes the data in the MRAM 20. An unillustrated sub CPU may be provided separately from the CPU 112 and the sub CPU may perform data check and data writing of the MRAM 20.

On the other hand, in a case in which the CPU 112 has determined that there is no data error in the F/W (developed) 303 of the MRAM 20 (S505), the CPU 112 executes the requested process. Here, as factors by which errors occur about the data stored in the MRAM 20 may include a software error in which the MRAM 20 is wrongly used as the work memory and data is wrongly rewritten because the MRAM 20 and the DRAM 21 are assigned in the same work memory area, and data loss in the MRAM 20 caused by, for example, application of static electricity and an influence of cosmic ray and the like.

After detecting the data error and writing data in the MRAM 20, the CPU 112 determines whether the factor of the data check execution is a calibration execution request (S507). In a case in which it is determined that the factor of the data check execution is not a calibration execution request, the CPU 112 further determines whether the factor of the data check execution is a sleep shift request (S508). Here, in a case in which it is determined that the factor of the data check execution is a sleep shift request, the power supply state is shifted to the sleep state 5001 (S509). After shifting to the sleep state 5001, the apparatus stays in a waiting state of a restoration factor from sleep (S514).

On the other hand, if the CPU 112 determines that, from the standby state (S503), there has not been a sleep shift request (S501) and, at the same time, there has been a power OFF request (S502), proceeds to 5504. In 5504, the CPU 112 checks data of the F/W (developed) 303 stored in the MRAM 20 as described above (S504).

Here, the power OFF state refers to, as illustrated in FIG. 4C, a state in which the power supply to all the parts constituting the controller unit 101 is blocked. In the state transition illustrated in FIG. 5, the power OFF state corresponds to a power OFF state 5002. The image forming apparatus 100 shifts from the standby state 5000 to the power OFF state when user operates to switch the power supply OFF or when previously power OFF time elapses 5007.

The image forming apparatus 100 starts up from the power OFF state 5002 and shifts to the standby state 5000 when, for example, the user operates to switch the power switch ON.

Here, description of the process illustrated in FIG. 3 will be given again.

In S505, after checking of the data error, if a data error is detected, the CPU 112 directly develops the compression F/W 302 stored in the ROM 113 to the MRAM 20 and performs writing (S506). If it is determined that there is no data error in the F/W (developed) 303 in the MRAM 20 (S505), the requested process is executed.

On the other hand, after the CPU 112 detects a data error and writes in the MRAM 20 (S506), the CPU 112 determines whether the factor of the data check execution is a calibration execution request (S507). Here, in a case in which the CPU 112 determines that the factor of the data check execution is not a calibration execution request, the CPU 112 determines whether the factor of the data check execution is a sleep shift request (S508). In a case in which the CPU 112 determines that the request is neither the calibration execution request nor the sleep shift request, the CPU 112 determines that the request is the power OFF request and shifts the state to the power OFF state (S510) and completes the process.

On the other hand, in S500, from the standby state, if the CPU 112 determines that there is no sleep shift request (S501) and that there is also no power OFF request (S502), the CPU 112 determines whether there is a calibration execution request that represents the need of tone adjustment to the image forming apparatus 100 (S503). Here, if the CPU 112 detects that the request is a calibration execution request, the CPU 112 checks the data of the F/W (developed) 303 stored in the MRAM 20 (S504).

Here, when the CPU 112 performs the data check execution and detects the data error (S505), the CPU 112 directly develops the compression F/W 302 stored in the ROM 113 to the MRAM 20 and performs writing (S506). In a case in which the CPU 112 determines in S505 that there is no data error in the F/W (developed) 303 in MRAM 20, the requested process is executed.

After the CPU 112 detects a data error in S505 and writes in the MRAM 20 in S506, the CPU 112 determines whether the factor of the data check execution is a calibration execution request (S507). Here, in a case in which the CPU 112 determines that the factor is the execution request of calibration, the CPU 112 executes calibration (S512). When the CPU 112 terminates the calibration (S513), the image forming apparatus 100 returns to the standby state (S500) waiting for a subsequent process.

In S503, in a case in which the CPU 112 determines that the calibration execution is unnecessary, the standby state waiting for a print request is continued (S500). In the present embodiment, the CPU 112 executes calibration after detecting a data error and starting writing in the MRAM 20, but these processes may be performed in parallel or in any order.

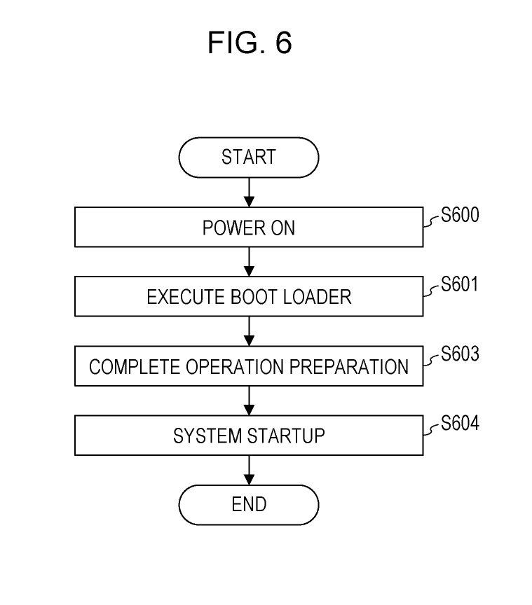

FIG. 6 is a flowchart illustrating a method for controlling the image forming apparatus which represents the present embodiment. This example is a process example at the time of start-up of the image forming apparatus 100. Each step is implemented when the CPU 112 executes the control program.

A process in accordance with turning on of the image forming apparatus 100 by, for example, a power switch is started (S600) and the CPU 112 is started in accordance with the boot loader 301 which is an initialization program of the ROM 113 (S601). Immediately thereafter, the program of the developed F/W 303 stored in the MRAM 20 becomes executable by the CPU 112, operation preparation is completed (S603) and the system is started (S604).

Therefore, the processes of developing the compression F/W 302 stored in the ROM 113 to the MRAM 20 and writing the developed F/W 303 in the MRAM 20 that have been conventionally executed at the time of start-up in accordance with the boot loader 301 which is the initialization program can be omitted. Therefore, it is possible to always reduce the start-up time and to secure data reliability by performing data check described above.

### Other Embodiments

Embodiments of the present invention can also be realized by a computer of a system or apparatus that reads out and executes computer executable instructions recorded on a storage medium (e.g., non-transitory computer-readable storage medium) to perform the functions of one or more of the above-described embodiment(s) of the present invention, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

The present invention is not limited to the embodiments described above and various modifications in accordance with the spirit of the present invention (including organic combinations of each embodiments) are possible, which modifications are not excluded from the scope of the present invention.

According to the embodiments described above, occurrence of a program error caused by inconsistency in the content of the program read from the first memory and the content of the program written in the second memory from the first memory may be prevented.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2013-181330, filed Sep. 2, 2013, which is hereby incorporated by reference herein in its entirety.

What is claimed is:

1. An image forming apparatus, comprising:
a first memory configured to store a program for executing a specific process;
a second memory configured to store a program read from the first memory;
a verifying unit configured to, in a case in which the image forming apparatus shifts to a specific state, verify a content of the program stored in the second memory; and
a first control unit configured to, in accordance with the verification result by the verifying unit, write the program read from the first memory in the second memory.

2. The image forming apparatus according to claim 1, wherein the case in which the image forming apparatus shifts to a specific state includes a case in which the image forming apparatus shifts to a second power state in which power is more saved than in a first power state, a case in which the image forming apparatus shifts to a state in which calibration is performed, and a case in which a power supply state of the image forming apparatus is made to shift to a power OFF state.

3. The image forming apparatus according to claim 1, wherein the specific process includes a process in which the image forming apparatus forms an image on a sheet.

4. The image forming apparatus according to claim 1, wherein the first memory is boot ROM.

5. The image forming apparatus according to claim 1, wherein the second memory is any of MRAM, FeRAM, PRAM and ReRAM.

6. The image forming apparatus according to claim 1, wherein the first memory and the second memory are connected to the same bus.

7. An image forming apparatus, comprising:
a first memory configured to store a program for executing a specific process;
a second memory configured to store a program read from the first memory; and
a second control unit configured to, in a case in which the image forming apparatus shifts to a specific state, write the program read from the first memory in the second memory.

8. The image forming apparatus according to claim 7, wherein the case in which the image forming apparatus shifts to a specific state includes a case in which the image forming apparatus shifts to a second power state in which power is more saved than in a first power state, a case in which the image forming apparatus shifts to a state in which calibration is performed, and a case in which a power supply state of the image forming apparatus is made to shift to a power OFF state.

9. The image forming apparatus according to claim 7, wherein the specific process includes a process in which the image forming apparatus forms an image on a sheet.

10. The image forming apparatus according to claim 7, wherein the first memory is boot ROM.

11. The image forming apparatus according to claim 7, wherein the second memory is any of MRAM, FeRAM, PRAM and ReRAM.

12. A method for controlling an image forming apparatus which includes a first memory configured to store a program for executing a specific process, and a second memory configured to store a program read from the first memory, the method comprising:
a verifying process in which, in a case in which the image forming apparatus shifts to a specific state, a content of the program stored in the second memory is verified; and
a first control process in which, in accordance with the verification result, the program read from the first memory is written in the second memory.

13. A method for controlling an image forming apparatus which includes a first memory configured to store a program for executing a specific process, and a second memory configured to store a program read from the first memory, the method comprising:
a second control process in which, in a case in which the image forming apparatus shifts to a specific state, the program read from the first memory is written in the second memory.

14. A program configured to make a computer execute the method for controlling the image forming apparatus according to claim 12.

15. A program configured to make a computer execute the method for controlling the image forming apparatus according to claim 13.
